(19) United States
(12) Patent Application Publication
(10) Pub. No.: US 2014/0059817 A1
(43) Pub. Date: Mar. 6, 2014

(54) PAPER CLIP

(71) Applicants: Nadim William George, Los Angeles, CA (US); Edward Michael Goldsmith, Encino, CA (US)

(72) Inventors: Nadim William George, Los Angeles, CA (US); Edward Michael Goldsmith, Encino, CA (US)

(21) Appl. No.: 14/015,949

(22) Filed: Aug. 30, 2013

Related U.S. Application Data
(60) Provisional application No. 61/695,211, filed on Aug. 30, 2012.

(51) Int. Cl. B42F 1/10

(52) U.S. Cl. CPC B42F 1/10
USPC 24/67 CF; 493/394

(57) ABSTRACT

Described, is a paper clip with improved performance and appearance. The paper clip comprises a lower envelope section formed from a face and a lower back part connected by a set of edges. An upper envelope section is formed from the face and an upper back part connected by a set of edges. A fold line is formed along the face. The upper envelope section is folded along the fold line such that by folding the upper envelope section along the fold line, the lower envelope section is able to receive corners of several pieces of paper. The lower envelope section is formed such that it serves as a fulcrum for the corners of the pieces of paper to be bent around to secure the pieces of paper. In a desired aspect, the paper clip is formed of paper or other sheet stock material.

### CROSS-REFERENCE TO RELATED APPLICATIONS

This is a Non-Provisional patent application of U.S. Provisional Application No. 61/695211, filed in the United States on Aug. 30, 2012, entitled, “Paper Clip”

### BACKGROUND OF THE INVENTION

(1) Field of Invention

The present invention relates to a paper clip and, more particularly, to a paper clip having elements that improve the functionality of the paper clip.

(2) Description of Related Art

Paper clips in a broad range of constructions are known in the prior art. In its most general form, the paper clip is a wire or plastic device formed of inter-nesting elongated loops. Over time, paper clips have evolved to include writing surfaces, such as described in U.S. Pat. No. 5,398,384, or to attempt to hold paper stacks with less damage.

Traditional paper clips work to hold multiple papers together; however, they have some significant drawbacks. First, the paper clips use both friction and compression to hold a stack of papers together. While this is functional to a point, it is not optimal because pages on the very bottom and very top of the stack which come in direct contact with the paper clip are more firmly held than those in the middle which can come lose or shift in position.

Further, when multiple stacks, each held together by a paper clip, are put in a file or stacked on top of one another, a common occurrence, the paper clips can become dislodged from the stack of papers they are meant to be holding as they are easily leveraged off. Pages can come lose, or pages from other stacks can become lodged in the wrong stack's paper clip confusing the bundles and failing the most basic goal of the paper dip—holding a single stack together and separating it from other papers.

Further, when manipulating a stack of papers bound together by a traditional paper clip, the clip is often levered off the stack when pages are turned. As the act of turning pages levers the paper clip open and reduces the compressive force, the pages act as a lever and overwhelm the strength of the paper clip. This problem is worsened as the bound stack becomes thicker and more pages are added.

Improved paper clips that allow a flat surface for writing also suffer from the functional drawbacks described above. Further, traditional paper clips have a limited aesthetic appeal to users who want to create a dressed up binding for handing out presentations, for example. Further, the materials and the process used to make traditional paper clips are often environmentally unfriendly. The electroplating process utilized in metal paper clips uses detergents, acid baths, and alkaline neutralizers in the process, all of which must eventually be disposed of and can be damaging to water sources and create other environmental damage. Further, non-metal paper clips, such as those made of plastic, or plastic encased metal, utilize materials that do not degrade easily creating more non-renewable waste.

Thus, a continuing need exists for a paper clip with improved performance and appearance that also utilizes a more environmentally-friendly process with fully renewable materials.

### SUMMARY OF THE INVENTION

The present invention relates to paper clip and, more particularly, to a paper clip having elements that improve the functionality of the paper clip. The paper clip comprises a lower envelope section formed from a face and a lower back part connected by a set of edges, and an upper envelope section formed from the face and an upper back part connected by a set of edges. A fold line formed along the face. The upper envelope section is folded along the fold line such that by folding the upper envelope section along the fold line, the lower envelope section is able to receive corners of a plurality of pieces of paper. The lower envelope section is formed such that it serves as a fulcrum for the corners of the plurality of pieces of paper to be bent around.

In another aspect, the corners of the plurality of pieces of paper are covered by the upper envelope section.

In another aspect, the lower envelope section is generally trapezoidal in shape to receive the corners of the plurality of pieces of paper.

In another aspect, the lower envelope section comprises a front side and a back side, wherein one of the back side and the front side extends further than the other side.

In another aspect, the lower envelope section comprises a lower back section having an upper edge, wherein the upper edge of the lower back section is bowed.

In another aspect, the upper envelope section comprises an upper back section haying a lower edge, wherein the lower edge of the upper back section is bowed downwardly.

In another aspect, the lower envelope section is formed such that it can be shaped into a cone.

The present invention further comprises a method for forming a paper clip from a sheet stock material, comprising acts of die-cutting the sheet stock material into a desired shape; folding the die-cut sheet stock material to form the desired paper clip shape, resulting in a folded paper clip shape; and gluing the folded paper clip shape to create an upper envelope section and a lower envelope section, wherein the lower envelope section receives a plurality of pieces of paper, and the upper envelope section secures the plurality of pieces of paper.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a perspective-view illustration of the paper clip according to the principles of the present invention;

FIG. 2 is a perspective-view illustration of the paper clip with the upper envelope section folded back according to the principles of the present invention;

FIG. 3 is a front, elevation-view illustration of the paper clip according to the principles of the present invention;

FIG. 4 is a rear, elevation-view illustration of the top and bottom half of the back faces of the paper clip according to the principles of the present invention;

FIG. 5 is an elevation-view illustration of the inside surface of the front of the paper clip according to the principles of the present invention;

FIG. 6 is an elevation-view illustration of the inside surfaces of the back two halves of the paper clip according to the principles of the present invention;

FIGS. 7A-7D are perspective-view illustrations of the paper clip in various stages of implementation binding a paper stack according to the principles of the present invention;

FIGS. 8A-8D are sectional-view illustrations of the paper clip in various stages of implementation binding a paper stack according to the principles of the present invention;

FIG. 9 is an elevation-view illustration of the paper clip having an additional overlapping layer according to the principles of the present invention; and

FIGS. 10A-10D are sectional-view illustrations of the paper clip having an additional overlapping layer in various stages of implementation binding a paper stack according to the principles of the present invention.

### DETAILED DESCRIPTION

The present invention relates to paper clip and, more particularly, to a paper clip having elements that improve the functionality of the paper clip. The following description is presented to enable one of ordinary skill in the art to make and use the invention and to incorporate it in the context of particular applications. Various modifications, as well as a variety of uses, in different applications will be readily apparent to those skilled in the art, and the general principles defined herein may be applied to a wide range of embodiments. Thus, the present invention is not intended to be limited to the embodiments presented, but is to be accorded with the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter-clockwise have been used for convenience purposes only and are not intended to imply any particular fixed direction. Instead, they are used to reflect relative locations and/or directions between various portions of an object. As such, as the present invention is changed, the above labels may change their orientation.

(1) Specific Details

The present invention is a unique paper binding clip that improves the functionality of the paper clip by holding papers more securely throughout the stack, attaching to the corner securely enough to resist being levered off when pages are turned. By simultaneously attaching to the corner and holding the paper stack more securely, this paper clip facilitates page turning without slippage, or being levered off. Additionally, this paper clip can be made of paper, which adds many other advantages, like the ability to make it from totally renewable resources, creating a writing surface, and giving an improved appearance over traditional metal and plastic binding methods.

Although specific aspects of the present invention are described with reference to the drawings, it should be understood that such aspects are by way of example only, and merely illustrative of some of the advantages of the aspects of the invention. Various alterations are possible and clear to anyone skilled in the art of binding of paper stacks or creating notation space for a piece of paper.

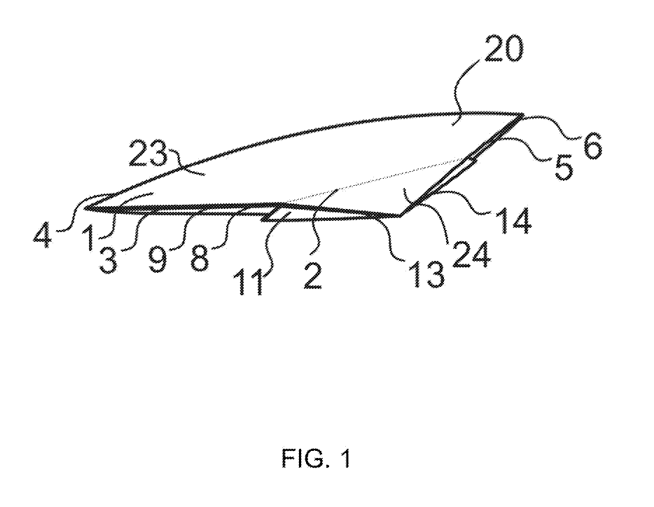

FIGS. 1-6 show a desired aspect of the present invention in various stages. FIG. 1 shows a paper clip 20 in a perspective view. A face 1 is connected to a lower back part 8 at a first set of edges 3 and 9, respectively forming one side of a lower envelope. The face 1 is also connected to the lower back part 8 at a second set of edges 5 and 6. Together, these two connected parts, the face 1 and the lower back part 8, create a lower envelope section 23. An upper envelope section 24 is created when the face 1 is connected to an upper back part 11, as the edge 3 and an edge 13 are connected and the edge 5 and an edge 14 are also connected. Together, the face 1 and the upper back part 11 connect together as described creating the upper envelope section 24.

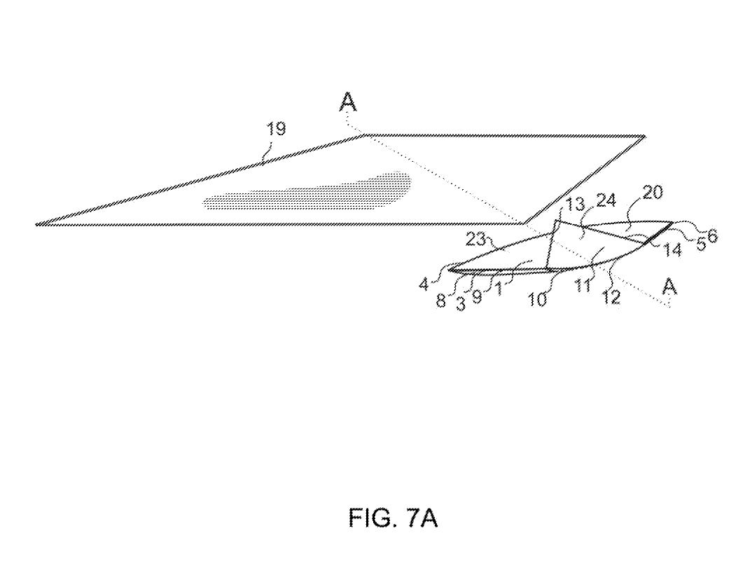

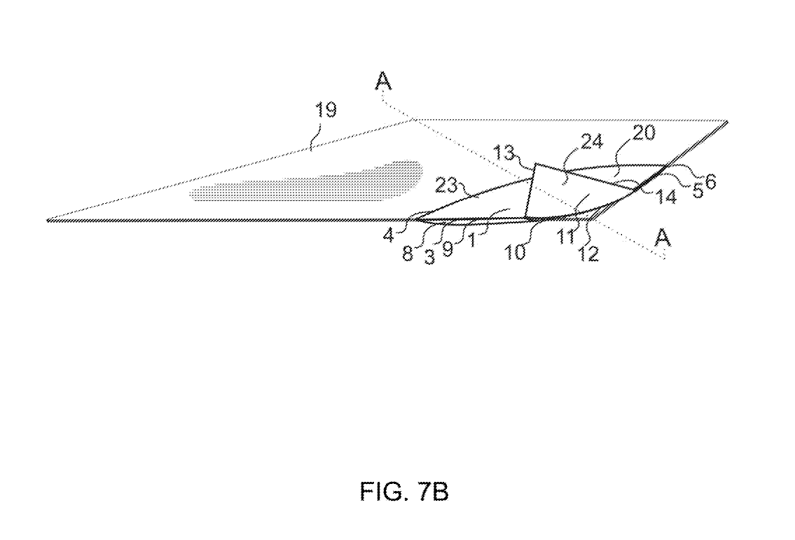

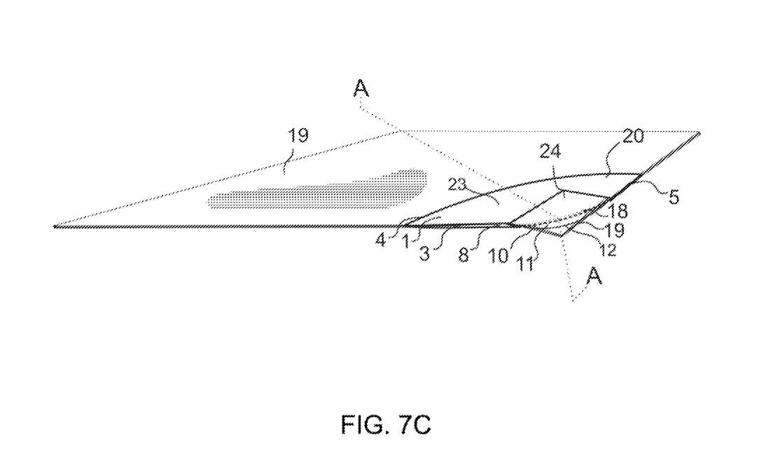

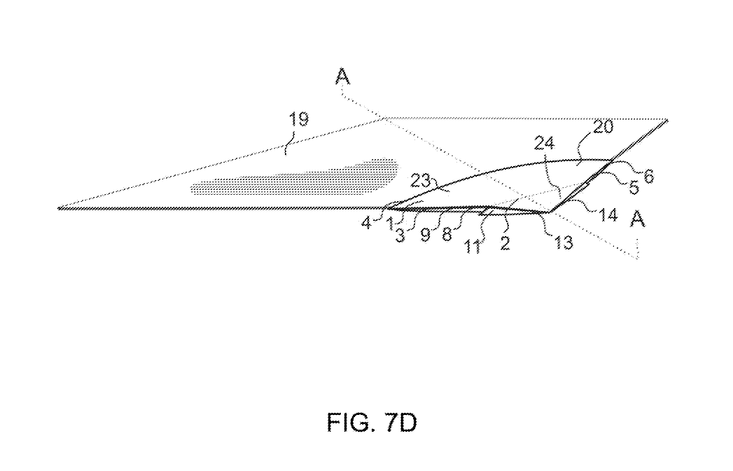

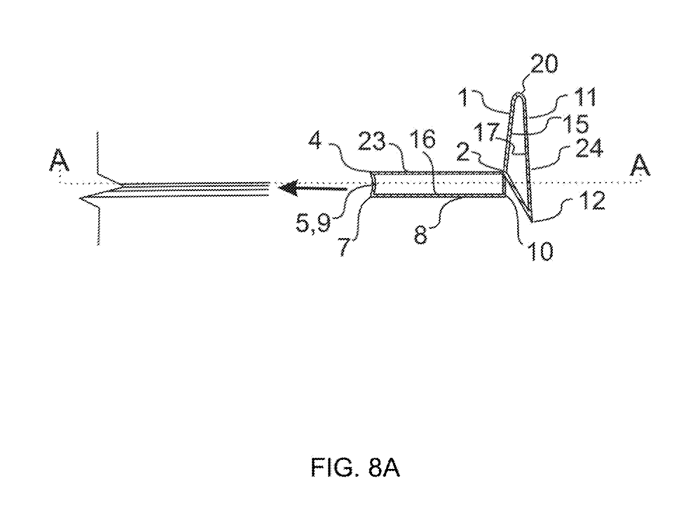

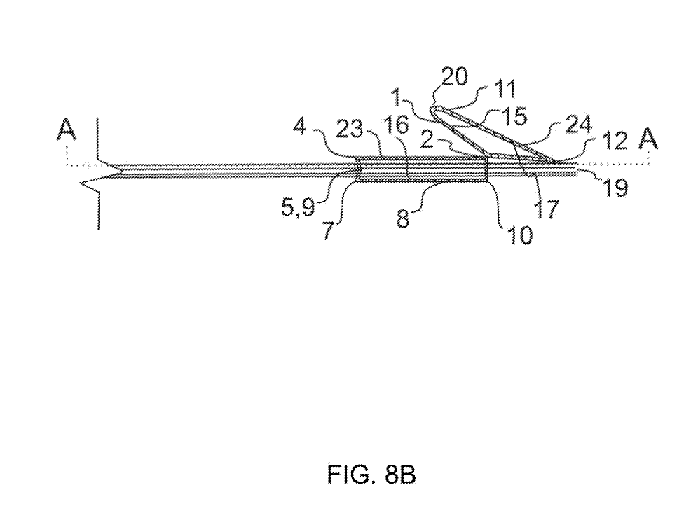

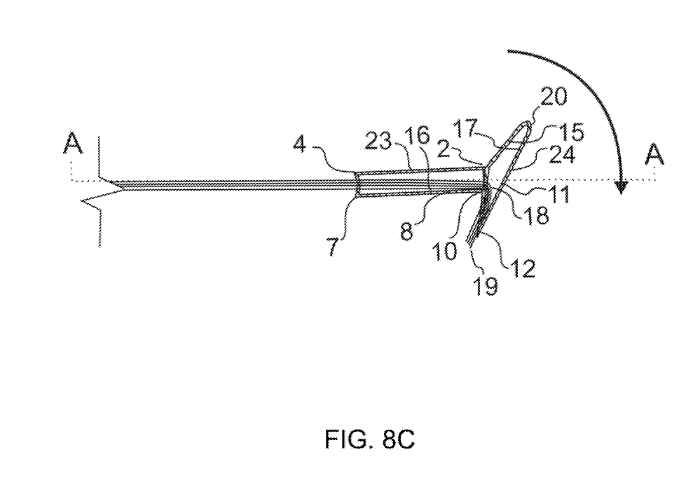

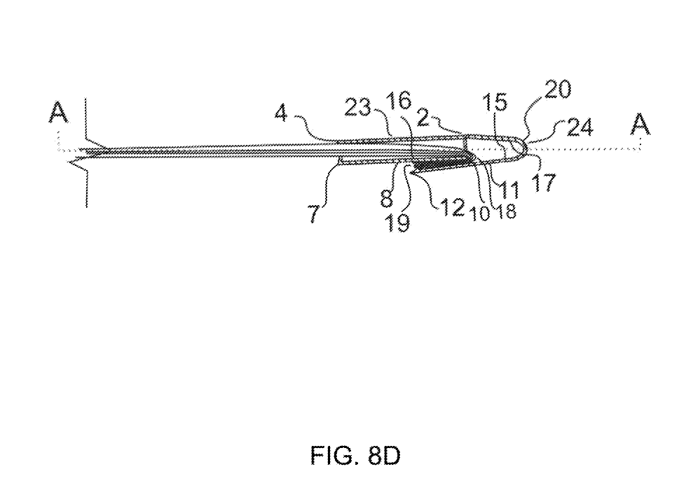

As shown in FIGS. 7A-7D and FIGS. 8A-8D, the lower envelope section 23 is designed to receive a paper stack 19, providing a fulcrum created by a top edge 10 for the paper stack 19 to be folded or “dog eared” around. The upper envelope section 24 is there to hide and lock dog-eared corners of the paper stack 19.

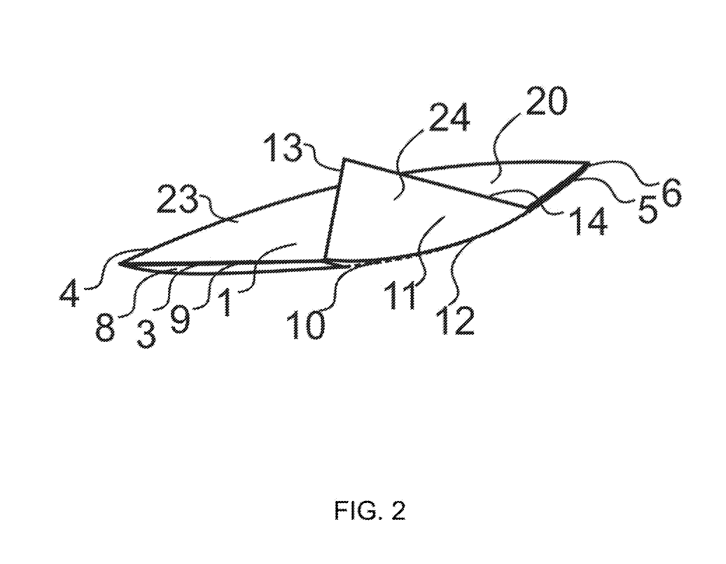

FIG. 2 illustrates the paper clip 20 with the upper envelope section 24 folded forward along a fold line (the fold line 2 is depicted in FIG. 1). By folding forward the upper envelope section along the fold line, the lower envelope section 23 is open and available for the paper stack to be inserted.

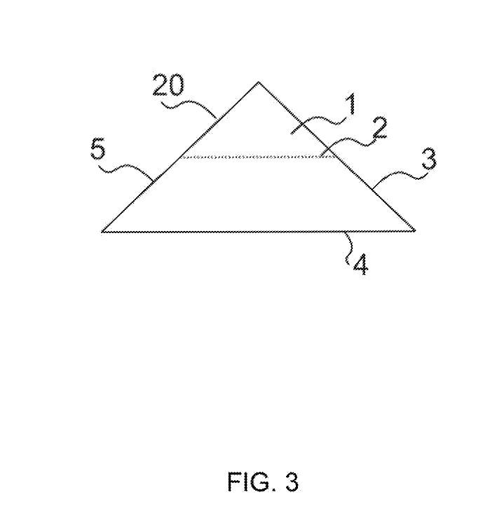

FIG. 3 is a front, elevation-view of the face 1 of the paper clip 20. The dotted fold line 2 is a line along which the face 1 can be folded both forward and backwards to accept then fold the paper stack. The face 1 has a lower edge 4, a left-side edge 5, and a right-side edge 3.

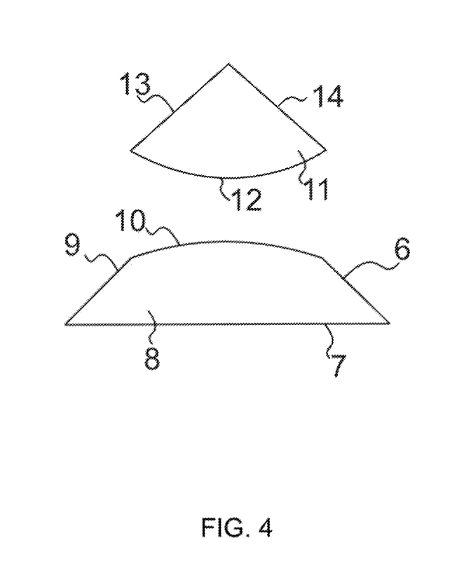

FIG. 4 shows two parts which make up the back of the paperclip 20. The back of the lower back part 8 has a lower edge 7, a left-side edge 9, and a right-side edge 6. It also has a top edge 10, which is bowed outwardly from the center of the lower back part 8. Also depicted in FIG. 4 is the upper back part 11 which has left edge 13, a right edge 14, and a lower edge 12, which is bowed downwardly away from the center of the upper back part 11.

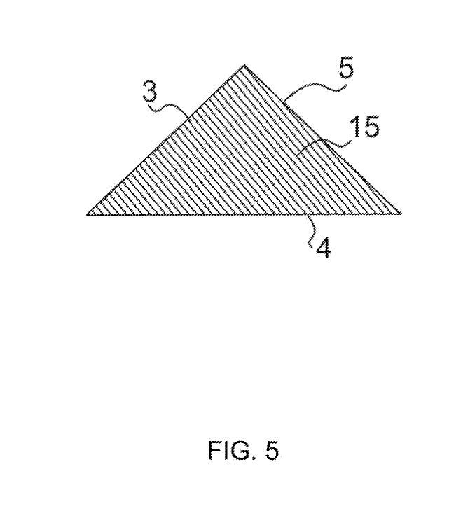

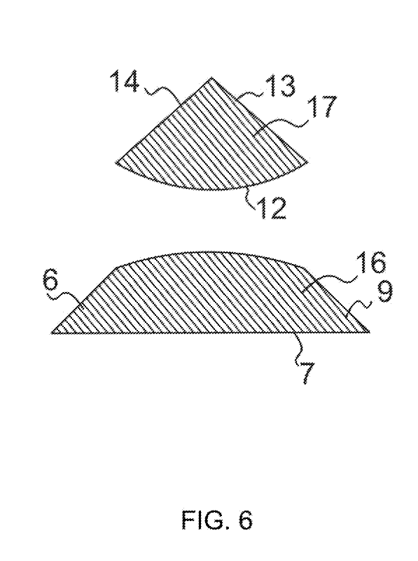

FIG. 5 is an illustration of the inside surface of the face 1, showing the inside surface 15 of face 1. FIG. 6 shows an inside surface 16 of the lower back part 8 and an inside surface 17 of the upper back part 11.

FIGS. 7A-7D are perspective-view illustrations of the various stages of operation, where the paper clip 20 can be folded back on itself along a fold line (not shown). In this configuration, the lower envelope section 23 is exposed so that the paper stack 19 can be slid in to the lower envelope section 23, while the paper stack 19 does not enter the upper envelope section 24 which has been pivoted out of the way by folding the face 1 along the fold line. Thus, the fold line creates a hinge for the upper envelope section 24 to be moved out of the way to allow the paper stack 19 to enter the lower envelope section 23 without interfacing with the upper envelope section 24.

The paper stack 19 is then slid into the lower envelope section 23 until the edges of the paper stack 19 interface with both the right-side edge 3 and the left-side edge 5. Thus, the paper stack 19 bottoms out in the paper clip's 20 lower envelope section 23. Once this has occurred, the upper envelope section 24 can be folded down, rotating around the fold line. As this occurs, the lower edge 12 comes in to contact with the top of the paper stack 19, pressing it downwards and bending it around the relatively rigid top edge 10 of the lower envelope section 23. This allows the paper clip 20 to sit relatively flat, while the paper stack 19 is now dog-eared around the rigid top edge 10 and covered by the upper envelope section 24.

FIGS. 8A-8D shows cross-sectional views of the stages of operation along an axis A-A, where the paper clip 20 can be folded back on itself along the fold line 2. In this configuration, the lower envelope section 23 is exposed so that the paper stack 19 can be slid in to the lower envelope section 23 while the paper stack 19 does not enter the upper envelope section 24, which has been pivoted out of the way by folding the face 1 along the fold line 2. Thus, the fold line 2 creates a hinge for the upper envelope section 24 to be moved out of the way to allow the paper stack 19 to enter the lower envelope section 23 without interfacing with the upper envelope section 24.

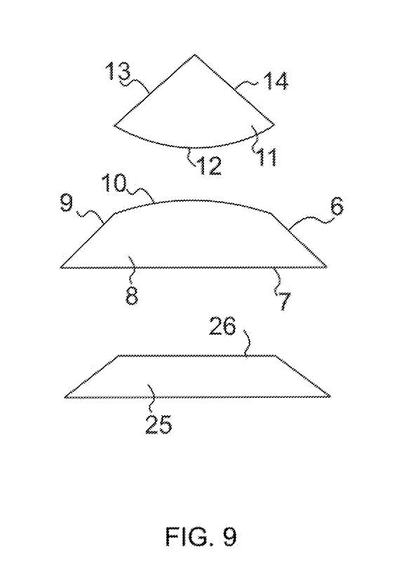

FIG. 9 shows a perspective view illustration of the three parts that make up the back of paper clip 20 when combined together. In this embodiment, layer 25 is placed on top of lower back part 8 so as to form an additional envelope which lower edge 12 of upper back part 11 can be tucked in to when upper envelope section 24 has been folded in to position “dog earing” paper stack 19.

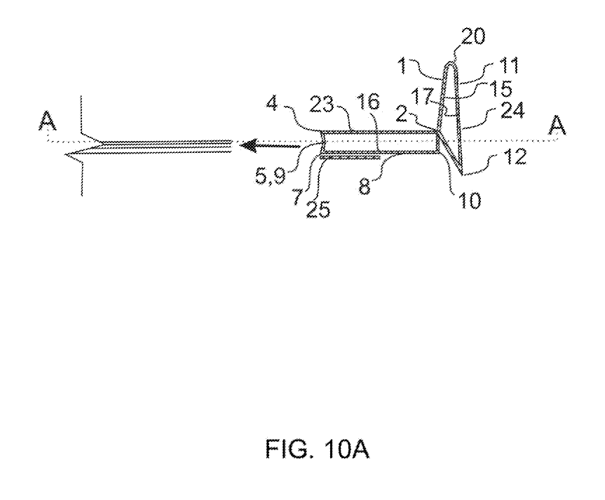

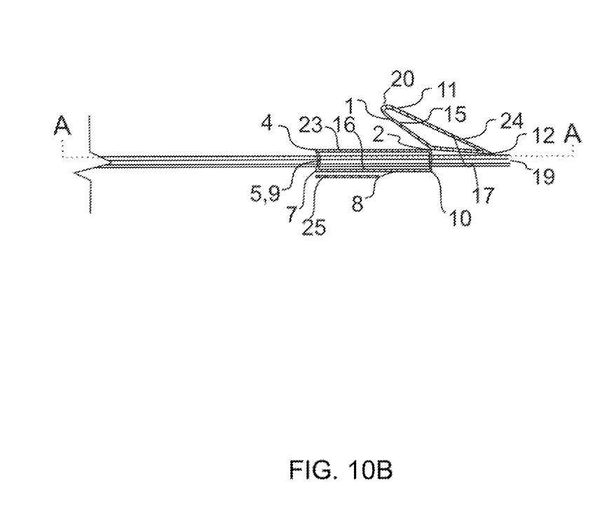

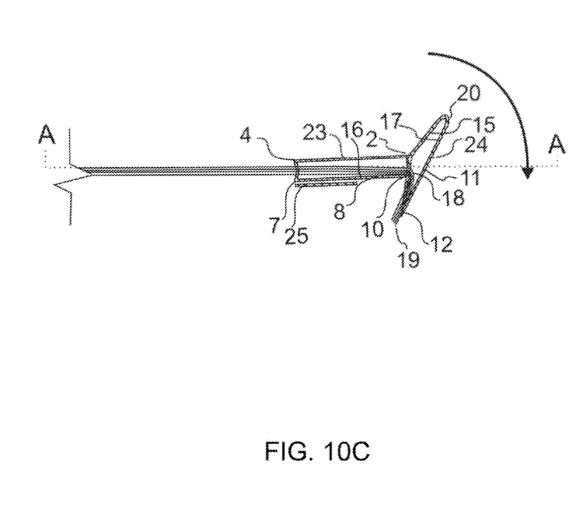

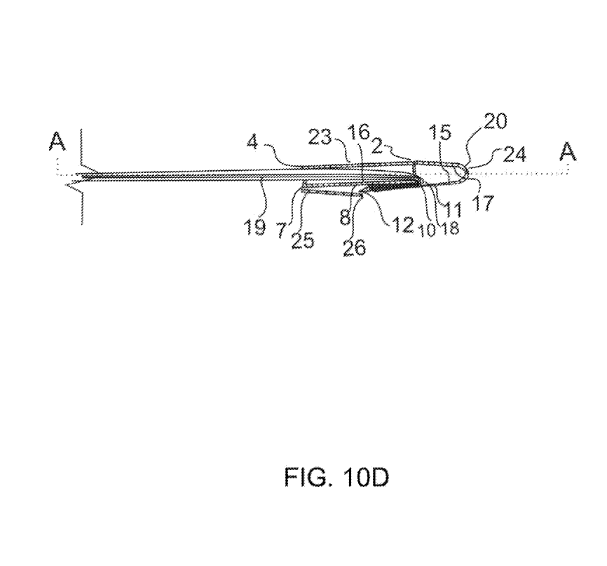

FIG. 10 A-D shows cross sectional views of the stages of operation along an axis A-A, where paper clip 20 can be folded back on itself along the fold line 2. In this configuration, the lower envelope section 23 is exposed so that the paper stack 19 can be slid in to the lower envelope section 23 while the paper stack 19 does not enter the upper envelope section 24, which has been pivoted out of the way by folding the face 1 along the fold line 2. Thus, the fold line 2 creates a hinge for the upper envelope section 24 to be moved out of the way to allow the paper stack 19 to enter the lower envelope section 23 without interfacing with the upper envelope section 24. The upper envelope section 23 is folded down in to place, “dog earing” paper stack 19. Then the lower edge 12 of upper envelope section 23 can be tucked under layer 25 to lock paperclip in place.

The paper stack 19 is then slid into the lower envelope section 23 until the edges of the paper stack 19 interface with both the right-side edge (not shown) and the left-side edge 5 (not shown). Thus, the paper stack 19 bottoms out in the paper clip's 20 lower envelope section 23. Once this has occurred, the upper envelope section 24 can be folded down, rotating around the fold line. As this occurs, the lower edge 12 comes in to contact with the top of the paper stack 19, pressing it downwards and bending it around the relatively rigid top edge 10 of lower envelope section 23. This allows the paper clip 20 to sit relatively flat, while the paper stack 19 is now dog-eared around the rigid top edge 10 and covered by the upper envelope section 24.

In another aspect, the lower back part 8 has a top edge 10 reinforced by adding a second layer of material, or by folding the lower back part 8 back upon itself so that the top edge 10 is made stronger and more reinforced. There are, of course, many obvious ways that anyone skilled in the art could reinforce the top edge 10 that would be acceptable provided the reinforcement performed its intended function of creating a fulcrum for the paper stack 19 to fold around.

In order to make it easier to slide the paper stack 19 in to the lower envelope section 23, the lower back part 8 can have a slightly different angle than the face 1 so that when the two are connected together along their edges, it creates a coning or opening to the lower envelope section 23. Another means to help the paper stack 19 slide in to the lower envelope section 23 more easily is for the lower edge 7 and the lower edge 4 to end at different lengths, thus exposing one of the two layers to allow the user to insert the paper stack 19 more easily between the two layers, the face 1 and the lower back part 8.

In another aspect, and as shown in FIG. 9 and FIGS. 10A-10D, an additional overlapping layer 25 has been attached to the paper clip 20 body so that the upper back part 11 may be tucked underneath the overlapping layer 25 at its top edge 26 as depicted in FIGS. 10A-10D.

Furthermore, the present invention also includes a method for forming the paper clip described herein. The paper clip is made from paper or other sheet stock material. The material is laid flat and die-cut in the predetermined shape. The die-cut A method for making a paper clip from paper or other sheet stock material where the sheet stock is laid flat, and die cut. The die-cut material is folded, preferably along scribed or indented lines, and folded to form the desired paper clip shape as described above. The folded paper clip shape is then glued to hold the folded shape together while creating an upper envelope section and a lower envelope section.

Another method for forming the paper clip is to injection mold the paper clip. Using any suitable plastic, like Poly Propylene (PP), Poly Ethylene (PE), or Acrylonitrile Butadiene Styrene (ABS) or others, the paper clip can be injection molded. Using known practices, a fold line 2 can be created by having a thin section of the injection mold create a divot or dent in the paper clip to act as a hinge. In this method, the mold is inserted in to the injection machine, then plastic is injected in to the mold, and the part is removed. On advantage of this method is the ability to create a cone shape in the upper or lower envelope sections, which can be useful for holding a thicker paper stack 19 and inserting paper stack 19 in to the paper clip 23.

What is claimed is:

1. A paper clip for retaining together at least two pieces of paper comprising:
a lower envelope section formed from a face and a lower back part connected by a set of edges;
an upper envelope section formed from the face and an upper back part connected by a set of edges;
a fold line formed along the face;
wherein the upper envelope section is folded along the fold line such that by folding the upper envelope section along the fold line, the lower envelope section is able to receive corners of a plurality of pieces of paper; and
wherein the lower envelope section is formed such that it serves as a fulcrum for the corners of the plurality of pieces of paper to be bent around.

2. The paper clip as set forth in claim 1, wherein the corners of the plurality of pieces of paper are covered by the upper envelope section.

3. The paper clip as set forth in claim 1, wherein the lower envelope section is generally trapezoidal in shape to receive the corners of the plurality of pieces of paper.

3. The paper clip as set forth in claim 1, wherein the lower envelope section comprises a front side and a back side, and wherein one of the back side and the front side has a length greater than the other side.

4. The paper clip as set forth in claim 1, wherein the lower envelope section comprises a lower back section having an upper edge, and wherein the upper edge of the lower back section is bowed.

5. The paper clip as set forth in claim 1, wherein the upper envelope section comprises an upper back section having a lower edge, and wherein the lower edge of the upper back section is bowed downwardly.

6. The paper clip as set forth in claim 4, wherein the lower envelope section is formed such that it can be shaped into a cone.

7. A method for forming a paper clip from a sheet stock material, comprising acts of:
die-cutting the sheet stock material into a desired shape;
folding the die-cut sheet stock material to form the desired paper clip shape, resulting in a folded paper clip shape; and
bonding the folded paper clip shape to create an upper envelope section and a lower envelope section, wherein the lower envelope section can receive a plurality of pieces of paper, and the upper envelope section can secure the plurality of pieces of paper.
